(19) United States
(12) Patent Application Publication
(10) Pub. No.: US 2025/0135939 A1
(43) Pub. Date: May 1, 2025

(54) METHOD FOR DETERMINING DEFECTIVE CHARGING STATIONS

(71) Applicant: MERCEDES-BENZ GROUP AG, Stuttgart (DE)

(72) Inventors: Florian KIRCHNER, Kusterdingen (DE); Karsten SCHÖCK, Herrenberg (DE); Daniel SEIFERLEIN-SCHNEIDER, Calw (DE); Frederike DRECHSLER, Ulm (DE); Dominik FOLLI, Stuttgart (DE)

(21) Appl. No.: 18/693,592

(22) PCT Filed: Sep. 14, 2022
(86) PCT No.: PCT/EP2022/075480

§ 371 Date: Mar. 20, 2024

(30) Foreign Application Priority Data
Sep. 21, 2021 (DE) 10 2021 004 761.3

(51) Int. Cl. B60L 53/67; B60L 53/62; B60L 53/68

(52) U.S. Cl. CPC B60L 53/67; B60L 53/62; B60L 53/68

(57) ABSTRACT

Defective charging stations for battery-powered vehicles are identified by collecting usage data and transmitting the usage data to a central computing unit. The central computing unit analyzes the usage data, after which the central computing unit determines a malfunction of at least one charging station if at least one usage parameter of a charging station comprised by the usage data is inside or outside of a set target range. At least two charging stations, stationed in a set geographical area, of one or more charging station networks in a set geographical area, are assigned to a common charging station cluster and respectively the target range of the individual usage parameters is derived from the usage data of at least one charging station, classified as a reference charging station, of the charging station cluster.

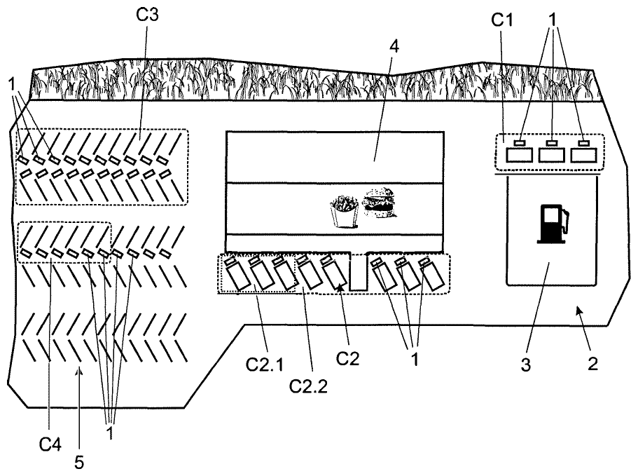

### BACKGROUND AND SUMMARY OF THE INVENTION

Exemplary embodiments of the invention relate to a method for determining defective charging stations for battery-powered vehicles.

Charging stations, often referred to as charging columns, enable the recharging of traction batteries of vehicles. Charging stations are available in a wide range of different designs. Charging stations differ, for example, by their charging interface, i.e., a usable plug or socket type, and by the current used for charging. Thus, there are charging stations which each have a charging interface for charging with direct current, alternating current, and/or three-phase current, each of which can provide different voltages and/or currents and accordingly different charging capacities. The higher the charging capacity, the faster a traction battery can typically be charged.

The charging process at a charging station takes comparatively longer than filling up a tank with liquid fuel, making it necessary to plan charging processes with a battery-powered vehicle in advance, particularly for a long journey. To this end, a vehicle driver will typically obtain information about where charging stations are located along their route and which constraints to charging there are, e.g., number of charging stations at the respective location, capacity (i.e., occupancy of the respective stations), electricity prices and similar. The vehicle driver can also use a charging stop route planner for this purpose. A charging station may not be available when a vehicle arrives for various reasons, e.g., due to a defect. This is annoying, in particular, for highly frequented places with a restricted number of charging stations, such as a motorway service area, as then vehicles must wait until a charging station is free or not all of the vehicles can charge at the same time.

Charging stations can typically record a status and transmit it to a third-party, for example, an operator of the charging stations. The status can comprise one of the states “available”, “in use/occupied”, “deactivated”, or “out of order”, for example. However, it is possible that a charging station incorrectly records its actual status, for example it has a malfunction but transmits the status “available”. As a result, the user comfort for a driver of a battery-powered vehicle can be restricted, as the vehicle driver may assume that they can charge their vehicle at the defective charging station. Incorrect detection can naturally also lead to the transmission of a different status, for example “occupied”.

Thus, there is a need to provide improved methods for determining actually defective charging stations.

A method and a device for evaluating the reliability of charging stations for electric vehicles are known from WO 2021/089914 A1. According to the method disclosed in the document, usage data collected over time for a charging station is analyzed by a computing unit and investigated for the existence of a minimum number of charging processes carried out at the charging station with a charging duration below a specified limit value. Depending on the number of such charging processes, a reliability factor for this charging station is then determined. Further variables can also be included in this calculation, such as usage of the charging station, a number of charging processes in which only a quantity of energy below a specified limit value was transmitted, a number of failed charging processes, or similar.

A similar method for monitoring charging stations is also known from WO 2021/028615 A1. The method provides the use of a machine learning model in order to analyze charging station usage data received from a charging station network. With the aid of the method disclosed in the document, charging stations with malfunctions can be recognized and future charging station failures can be predicted with a probability value. For this purpose, not only the usage data of a charging station, but also the usage data of several charging stations of the charging station network can be evaluated.

Exemplary embodiments of the present invention are directed to an improved method for determining defective charging stations for battery-powered vehicles, which method enables a particularly reliable conclusion to be drawn as to whether the charging station is actually out of order or is available for carrying out charging processes.

With a method for determining defective charging stations of the aforementioned type, charging stations transmit usage data to a central computing unit for analysis, after which the central computing unit determines a malfunction of at least one charging station if at least one usage parameter comprised by the usage data is outside a set target range, wherein according to the invention at least two charging stations of one or more charging station networks, the charging stations being stationed next to each other in a set geographical area, are assigned to a common charging station cluster and in each case the target range of the individual usage parameters is derived from the usage data of at least one charging station, classified as a reference charging station, of the charging station cluster.

With the aid of the method according to the invention, the accuracy of the conclusion as to whether a charging station is actually defective can be improved compared to known methods. This is based on the direct comparison of charging stations stationed in close proximity to each other, as such charging stations have a similar usage behavior and thus enable a direct comparison of the usage behavior, whereby “typical” usage patterns and corresponding deviations from these typical usage patterns can be detected. By determining “atypical” usage of at least one charging station, the requirement that a person must first manually report a defective charging station in order to recognize it as a defective charging station can be dispensed with, for example.

The set geographical area is, for example, a car park of a shopping center or furniture store, a motorway service area, a road section, or similar. In this case, next to each other means an indirect or direct stationing of the charging stations in close proximity to each other. The distance between two charging stations stationed directly next to each other is typically in the region of one or more vehicle widths or vehicle lengths. In the case of charging stations spaced apart indirectly, there can be obstacles located between the individual charging stations belonging to a charging station cluster, such as trees, walls, street lamps, green spaces, buildings, building sections or also parking areas without a charging station, for example. The charging stations can be arranged in a row or also in several rows, for example in a matrix form. The individual rows can also be offset in relation to each other and/or tilted at an angle to each other. It is also possible that one charging station has multiple, for example two, charging interfaces for charging several vehicles simultaneously.

For example, a charging station cluster is formed of four charging stations (and corresponding parking spaces) placed directly next to each other in a row between a pavement and a road in front of a restaurant. In another charging station cluster, for example, two charging stations are located in front of a first building side of a high-rise building and two other charging stations are located on the opposite side to the respective building side of the high-rise building. Despite this, the four charging stations can be assigned to a common charging station cluster, even though a high-rise building is located between the individual charging column pairs, as the usage behavior of the four charging columns is the same, i.e., the same typical usage patterns can be recognized from the usage parameters.

The central computing unit, for example, determines at least one reference charging station. The central computing unit can determine exactly one charging station as the reference charging station, for example. To do this, the central computing unit selects the newest charging station, i.e., the charging station that was installed the most recently, as the new components are less likely to malfunction compared to older charging stations. The usage behavior of the reference charging station is then taken into account. The different usage parameters will be discussed later, with the charging duration of a charging process being mentioned at this point as a usage parameter. For the reference charging station, the charging duration of more than 78% of charging processes carried out at the reference charging station in a defined time interval, for example one day, one week or several months, is in a value range of 30-40 minutes. This value range is then used as a target range for the further charging stations of the charging station cluster. If such a charging station then has a specified number of charging processes, for example already one, or for example at least 50% of the charging processes carried out at this charging station in a defined time interval, in which the charging duration is only 5 minutes or, for example, a full 60 minutes, a defect or malfunction is determined for this charging station. A charging duration may be “too short” if a vehicle driver promptly notices that a charging process is not taking place in the predicted manner, for example due to too low a charging capacity, and accordingly ends the charging process. A charging duration may be “too long” if the vehicle driver does not notice the malfunction, and then the traction battery of the vehicle is only sufficiently charged after 60 minutes due to the reduced charging capacity, for example.

The central computing unit can also specify, for example, that only “successful” charging processes should be considered for determining the valid value range. A charging process is only successful, for example, if a specified minimum energy quantity has been charged, 20 kWh for example.

The different charging stations of a common charging station cluster can be assigned one or more charging station networks. A charging station network is the entirety of all charging stations operated by a particular provider, for example. The method according to the invention therefore allows the charging stations of different providers, for example Allego, Ionity, EnBW or similar, to be compared simultaneously. To this end, the central computing unit has a communication connection with corresponding infrastructure of the charging station network operators.

At least one reference charging station can also be determined depending on usage patterns recognized in the usage data.

Usage patterns can be recognized in a variety of ways by the central computing unit in the usage data received from the charging stations over time. For example, a usage pattern can exist if a respective usage parameter for a specified portion of the charging processes carried out at the charging stations of a charging station cluster is in a usage parameter-individual value range. The specified portion can be a frequency of at least 50%, 60%, 70%, 80%, or 90% of the charging processes, for example. A corresponding usage parameter (e.g., the charging duration) in the case of more than half of the charging processes carried out at the charging stations of the charging station cluster in the specified time period is therefore in the usage parameter-individual value range (e.g., 30-45 minutes). To locate usage patterns, a plurality of usage parameters can also be considered simultaneously (e.g., a charging capacity of X-Y kW, during a charging process of M to N minutes) and several usage parameters can also depend on each other.

Accordingly, an advantageous development of the method provides that a group of reference charging stations, i.e., at least two reference charging stations, is considered when deriving the respective usage parameter-individual target ranges, wherein those charging stations having respective usage parameters matching within a set tolerance threshold are used as reference charging stations. This eliminates the need for the central computing unit to arbitrarily determine the reference charging station(s). In other words, the charging stations of a charging station cluster are automatically determined as reference charging stations, which also results in the typical usage behavior of the charging station. Therefore, the risk that a charging station that does not actually exhibit typical usage behavior, or at least distorts this, is chosen arbitrarily as a reference charging station is reduced.

Referring back to the example of charging duration, the charging durations of three charging stations of a charging station cluster, comprising four stations, for a specified observation period of, for example, one day, two weeks, or one month, are all in the range between 8 minutes to 125 minutes. For a fourth, defective charging station of the charging station cluster, the charging duration of all charging processes, however, is in the range of from 30 seconds to 2.5 minutes and thus differs significantly from the charging durations of the functional charging stations. Accordingly, the functional charging stations are determined as reference charging stations and the target range for the charging duration for example is set to 20-25 minutes, as 75% of the charging processes are in this time frame. If, instead of 75%, a larger or smaller value is chosen, the charging duration shifts accordingly, for example to 18-35 minutes or 21-22 minutes.

According to a further advantageous embodiment of the method according to the invention, at least half of the charging stations of a charging cluster are used as reference charging stations. By using at least half of the charging stations of a charging station cluster, it is possible to particularly reliably determine typical usage parameters of functional charging stations for a charging station cluster. If only one charging station at a charging station cluster of four charging stations is used as a reference charging station, there is the risk that the usage behavior of this charging station does not sufficiently reflect the actual typical usage behavior. It is therefore unclear which charging station should be determined as the reference charging station in an automatic selection. However, if at least half of the charging stations of a charging station cluster are used as a reference charging station, this risk can be reduced, as therefore a larger quantity of usage data is considered for finding usage patterns.

The approach is such that initially the usage parameters of all the charging stations are evaluated for a set time interval. For each usage parameter, set tolerance thresholds are determined regarding how much the usage parameters of individual charging stations may differ so that they are characterized as a reference charging station. Fixed values can be defined as tolerance thresholds, so that potentially no reference charging stations can be found (for example because the charging stations differ too greatly from each other), or these values can be defined depending on the usage parameters received from the central computing unit. Then the reference charging stations are determined, and the target ranges of the usage parameters are specified. It is then checked whether the usage parameters of the remaining charging stations are outside of the respective target ranges, for example because at least one charging process outside the corresponding target range was carried out.

The charging duration for over 80% of the charging processes carried out at one charging station is, for example, 23-31 minutes for the first charging station, 18-22 minutes for the second charging station, 1-4 minutes for the third charging station, and 24-29 minutes for the fourth charging station. Accordingly, the first, second, and fourth charging stations are selected as reference charging stations and the target range for the duration of charging processes is, for example, determined to be 16-35 minutes for at least 65% of the charging processes carried out at one charging station. On the basis of the significant difference, the third charging station is then determined to be defective.

A further advantageous embodiment of the method further provides that at least two charging station clusters are determined for one area. The further differentiation of charging stations stationed within one area into more than one charging station cluster allows for more refined differentiation of the usage data of the individual charging stations and thus recognition of subtler differences in the usage patterns derived from the usage parameters or recognized in these. This also enables charging stations to be divided according to their characteristics into individual charging station clusters. This allows even more reliable differentiation between functional and non-functional charging stations.

According to a further advantageous embodiment of the method according to the invention, at least one of the following charging station characteristics is checked in order to determine that at least two charging stations are stationed in a common area next to each other:
a geoposition;
an identification number;
an identification name;
an identification address; and/or
an area token.

In general, it is possible for charging stations to transmit specific charging station characteristics, or meta data, to the central computing unit or for the central computing unit to retrieve the corresponding charging station characteristics from the charging stations. A geoposition, a unique identification number, an identification name, an identification address, and/or an area token are included as charging station characteristics. At least a part of the identification number for charging stations arranged in a charging station cluster, i.e., a charging stations installed in particular street section of a street running through an area, can be the same. The identification number can comprise 15 digits for example, wherein a sequence of five consecutive digits is then the same for the charging stations in the same charging station cluster, for example. The same applies to an identification name in which letters are used instead of numbers. There can also be a mix of letters and digits and/or special characters. Thus, an identification address of a charging station can generally comprise any combination of letters, digits, and/or special characters such as spaces or hyphens. The meta information can also comprise an area token that is representative of the specific geographical area or at least of one section of the specific geographical area. An area token can comprise information such as, for example: parking space in front of the restaurant XY with the address 17 Main Street or parking space at A5 motorway service station, 217 kilometers, parking rows 4 and 5. The geoposition can comprise geo coordinates for example, particularly GPS coordinates. With the aid of the aforementioned charging station characteristics, a unique position determination of an installation site of a respective charging station is possible, which allows clear assignment of charging stations to charging station clusters.

A further advantageous embodiment of the method according to the invention further provides that at least one of the following usage parameters is used for forming the usage data:
a charging voltage and/or current during a charging process;
a charging capacity during a charging process;
a duration of a charging process;
an energy quantity transmitted during a charging process;
a time ratio of a period of time during which charging processes are carried out at a charging station to a period during which the charging station is not being used;
a number of charging processes for a set time interval;
a diagnostic state; and/or
a warning message.

In order to classify whether a charging station is functional or non-functional, an individual usage parameter of the charging stations can generally be compared, or an arbitrary combination thereof can also be considered. For example, the charging voltage and/or current during a charging process can be linked to a number of charging processes carried out in a set time interval. For example, the target range of a functional charging station can stipulate that no more than five charging processes may be carried out within one day with a charging voltage of less than 500 V, for example, and that at the same time at least 90 percent of the charging processes carried out at the charging station during the day must be carried out with a charging voltage of more than 500 V. In general, more than two usage parameters can also be linked, for example three usage parameters. For example, the target range can also be defined in such a way that the charging processes must then last at least 20 minutes for a corresponding charging station to be categorized as functional.

According to a further advantageous embodiment of the method according to the invention, only those charging stations of which the charging interface type matches and/or of which the usable charging capacity matches within a set tolerance threshold are included in a common charging station cluster. This allows similar charging stations to be integrated into charging station clusters. This prevents a particular charging station from being categorized as defective because it does not match the design of the other charging stations in the vicinity. It is also to be expected that the usage behavior of charging stations of different designs will also differ. For example, charging stations with a comparatively high charging capacity are typically used for shorter charging processes than charging stations with a lower charging capacity. This makes it possible to define a respective target range for individual usage parameters that is even more in line with the usage parameters of functional charging stations of the same type.

For example, only those charging stations that have the Combined Charging System (CCS) charging interface are included in a charging station cluster. Depending on their charging capacity, these charging stations can be divided into individual subclusters, for example charging capacity below 50 kW, charging capacity between 50 and 149 kW and charging capacity from 150 kW.

A further advantageous embodiment of the method according to the invention also provides that artificial intelligence is used by the central computing unit to analyze the usage data. With the aid of artificial intelligence, usage patterns in the usage data can be recognized even more reliably, even if no logical correlations between individual different usage parameters are expected. This enables an even clearer definition of the target range for functional charging stations. For example, a corresponding AI model can also set the tolerance threshold up to which the individual usage parameters of charging stations may differ so that they can be characterized as a reference charging station.

Preferably, information about a functional or non-functional operating status of at least one charging station is transmitted from the central computing unit for output to at least one vehicle. Accordingly, information about a charging station that is currently non-functional or will be non-functional in the future can be used by a person driving the vehicle to plan their route. In this way, the person driving the vehicle can be informed that it will probably not be possible to make a planned charging stop at a motorway service station on their route to a holiday destination because a charging station designated for making a charging stop and marked by a charging station operator as functional and free, i.e., not occupied, is in fact non-functional. This means that the person driving the vehicle is informed in good time about the charging station being out of order and can adjust their journey planning accordingly. This improves user convenience for the person driving the vehicle, as the method according to the invention reliably prevents the person driving the vehicle from wanting to carry out a charging process at an inoperative charging station. It is also possible for corresponding information to be called up via a web client, for example from outside the vehicle via a mobile device or via a PC with an existing Internet connection.

Information can be transmitted between charging stations, charging station clusters, charging station networks, central computing units, and/or vehicles in any way. For example, information can be transmitted by cable or wirelessly. In particular, at least some information is transmitted via the Internet. Preferably, vehicles are in communication with the central computing unit via mobile radio.

There is also the risk with the method according to the invention that a charging station has been incorrectly classified. Therefore, a confidence value can be determined as to how reliably a charging station has been correctly classified and the confidence value can be displayed in the vehicle. Based on this, a vehicle driver can decide for themselves whether they want to trust the assessment of the central computing unit. For example, the confidence value can be determined depending on how much the usage behavior of the individual charging stations in a charging station cluster, especially the reference charging stations, differs. If the respective usage parameters of the charging stations are very close to each other (for example, if the tolerance threshold with which the respective usage parameters of the reference charging stations may differ has a comparatively small value), a comparatively high confidence value, for example 95%, can be specified.

Further advantageous embodiments of the method according to the invention for determining defective charging stations also result from the exemplary embodiment, which is described in more detail below with reference to the single FIGURE.

### BRIEF DESCRIPTION OF THE SOLE FIGURE

The sole FIGURE shows a schematic top view of an area with several charging stations.

### DETAILED DESCRIPTION

The sole FIGURE shows a set geographical area 2, here in the form of a motorway service station. In the area 2, there is a petrol station 3, a restaurant 4, and a large continuous car park 5. Next to the petrol station 3 and in front of the restaurant 4, there are individual parking spaces. The parking spaces next to the petrol station 3, in front of the restaurant 4, and some of the parking spaces in the car park 5 each have a charging station 1 for charging battery-powered vehicles. For the sake of clarity, not all charging stations 1 are labelled with a reference symbol. The battery-powered vehicles can be purely battery-powered vehicles or plug-in hybrid vehicles.

Over the lifetime of a charging station 1, it often happens that a charging station operator reports that a charging station 1 is in working order, but the charging station 1 is actually defective. With the aid of a method according to the invention, such actually defective charging stations 1 can be determined. For this purpose, the use of charging stations 1 is compared with neighboring charging stations 1. This allows deviations in typical usage patterns to be recognized, which indicates a defect in a charging station 1.

For this purpose, charging stations 1 stationed next to each other in the area 2 are divided into at least one charging station cluster C1, C2, C3, C4. In the example in the sole FIGURE, the charging stations 1 next to the petrol station 3 are divided into a first charging station cluster C1, the charging stations 1 in front of the restaurant 4 are divided into a second charging station cluster C2, some of the parking spaces in the car park 5 are divided into a third charging station cluster C3, and some of the parking spaces in the car park 5 are divided into a fourth charging station cluster C4. Due to the spatial proximity of the charging stations 1 divided into the respective charging station clusters C1-C4, it can be assumed that the usage behavior of the respective charging stations 1 is similar. This makes it possible to classify a charging station 1 as defective if the usage behavior of this charging station 1 deviates from the usage behavior of the neighboring charging stations 1 of the respective charging station cluster.

In order to detect deviations from typical usage behavior, the usage data transmitted from the individual charging stations 1 to a central computing unit is analyzed and a malfunction of at least one charging station 1 is determined if at least one usage parameter of the usage data of a charging station 1 is outside a set target range. According to the invention, this target range is set individually for each charging station cluster C1-C4 depending on the usage data transmitted by the individual charging stations 1. This enables a particularly precise definition of the target ranges typical for functional charging stations 1, which means that defective charging stations 1 can also be detected particularly reliably.

For example, the utilization rate of the charging columns can be evaluated for a period of one hour. For example, the utilization rate of the charging stations 1 of a second subcluster C2.2, which will be discussed later, is 91%, 93%, 8%, 6% and 94%. The target utilization range is then determined depending on the current utilization. For example, it is specified that the individual charging stations may have a maximum utilization deviation of 35% from at least half of the charging stations 1 located in the second subcluster C2.2 in order to be considered functional. This applies to charging stations 1 with a utilization rate of 91%, 93% and 94%. Accordingly, the central computing unit determines a defect for the two charging stations 1 that have a utilization rate of 8% and 6%. In this example, a lower value, for example 5%, could also be selected as the tolerance threshold instead of 35%, as the maximum deviation between the charging station 1 with a utilization rate of 91% and the charging station 1 with a utilization rate of 94% is only 3%. Corresponding tolerance threshold values can be hard-coded or determined flexibly depending on the actual characteristics of the utilization parameters. In particular, artificial intelligence determines these tolerance threshold values.

For charging stations 1 to be included in a common charging station cluster C1-C4, they must be installed next to each other. In this context, next to each other means directly or indirectly next to each other. This means that, in general, all of the charging stations 1 assigned to the charging station clusters C1-C4 in the sole FIGURE could also be assigned to a single charging station cluster (not shown).

In the sole FIGURE, some charging stations 1 that are located in a row with the charging station cluster C4 are not assigned to the charging station cluster C4. There may be various reasons for this. For example, these charging stations 1 were excluded from the fourth charging station cluster C4 because the charging stations 1 have different designs. For example, the charging stations 1 not added to the fourth charging station cluster C4 have a different charging interface and should therefore be excluded from the functionality determination.

Charging stations 1 can also be differentiated by the maximum charging capacity they provide. For example, the second charging station cluster C2 can be divided into two subclusters C2.1 and C2.2. in this case, the charging stations 1 of the first subcluster C2.1, for example, have a maximum charging capacity of 50 to 149 kW and the charging stations 1 of the second subcluster C2.2 have a maximum charging capacity of over 150 kW. Accordingly, more or fewer subclusters can also be provided if a more precise differentiation by charging capacity is required.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the FIGURES enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-9. (canceled)

10. A method for determining a defective charging station of a plurality of charging stations for battery-powered vehicles, the method comprising:
collecting usage data of from the plurality of charging stations;
transmitting, by the plurality of charging stations to a central computing unit, the collected usage data;
analyzing, by the central computing unit, the usage data transmitted by the plurality of charging stations; and
determining a malfunction of one of the plurality of charging stations responsive to at least one usage parameter, comprised by the usage data, of one of the plurality of charging stations a charging station is outside a set target range,
wherein at least two of the plurality of charging stations stationed in a set geographical area are assigned to a common charging station cluster and the set target range is derived from usage data of at least one charging station of the at least two of the plurality of charging stations of the common charging cluster, wherein the at least one charging station is classified as a reference charging station

11. The method of claim 10, the reference charging station comprises a group of reference charging stations considered setting the target range, wherein charging stations of the plurality of charging stations having respective usage parameters matching within a set tolerance threshold are used as the reference charging stations of the group of reference charging stations.

12. The method of claim 11, wherein at least half of the charging stations of the common charging station cluster are used as the reference charging stations.

13. The method of claim 10, wherein at least two common charging station clusters are determined for the set geographical area.

14. The method of claim 10, wherein at least one of the following charging station characteristics is checked to determine that at least two charging stations are part of the common charging cluster by being stationed in a common area next to each other:
a geoposition;
an identification number;
an identification name;
an identification address; and
an area token.

15. The method of claim 10, wherein at least one of the following usage parameters is used for forming the usage data:
a charging voltage or current during a charging process;
a charging capacity during a charging process;
a duration of a charging process;
an energy quantity transmitted during a charging process;
a time ratio of a period of time during which charging processes are carried out at a charging station to a period during which the charging station is not being used;
a number of charging processes for a set time interval;
a diagnostic state; or
a warning message.

16. The method of claim 10, wherein only charging stations of the plurality of charging stations having a matching charging interface type matches included in the common charging cluster or only charging stations of the plurality of charging stations having a usable charging capacity within a set tolerance threshold are included in the common charging station cluster.

17. The method of claim 10, wherein the central computing unit analyzes the usage data using artificial intelligence.

18. The method of claim 10, further comprising:
transmitting, from the central computing unit to at least one vehicle, information about a functional or non-functional operating state of at least one charging station of the plurality of charging stations.
